(19) United States
(12) Patent Application Publication
(10) Pub. No.: US 2013/0339195 A1
(43) Pub. Date: Dec. 19, 2013

(54) PORTABLE INFORMATION PROCESSING APPARATUS, CARRYING-ORIENTED INFORMATION INPUT SYSTEM AND METHOD

(71) Applicant: TOSHIBA TEC KABUSHIKI KAISHA, TOKYO (JP)

(72) Inventors: Toshihiko Nogi, Chiba-ken (JP); Kazuo Masuda, Shizuoka-ken (JP)

(21) Appl. No.: 13/912,354

(22) Filed: Jun. 7, 2013

(30) Foreign Application Priority Data
Jun. 13, 2012 (JP) 2012-133962

(51) Int. Cl. G06Q 30/06

(52) U.S. Cl. CPC G06Q 30/0641
USPC 705/27.1

(57) ABSTRACT

A portable information processing apparatus includes a display configured to display information, a sending unit configured to send the information to an exterior, a commodity display unit configured to display multiple pieces of commodity information on the display, a designated commodity storage unit configured to store the information of a designated commodity in displayed commodities, an order inexistence designating unit configured to designate ordering inexistence and a printing information output unit configured to send the information of the ordering inexistence as printing information from the sending unit to an external printing apparatus in a situation that the ordering inexistence is designated by the ordering inexistence designating unit.

### CROSS-REFERENCE TO RELATED APPLICATION

This application is based upon and claims the benefit of priority from Japanese Patent Application No. 2012-133962, filed Jun. 13, 2012, the entire contents of which are incorporated herein by reference.

### FIELD

Embodiments described herein relate to a portable information processing apparatus, a carrying-oriented information input system and a method.

### BACKGROUND

Due to the popularization of a network in recent years, a sales manner (EC: Electronic Commerce) of selling a commodity through the network prevails. In addition, in a store such as a supermarket and the like, the sales manner of a so-called online supermarket selling the commodity sold in the store through the network is also carried out. In the online supermarket, when the ordering of commodity purchase is accepted from a customer through internet, the consistent commodity in the store is collected from the store, and then delivered to the residence of each customer, and the online supermarket is utilized in such a manner. Particularly, for the purchase of the heavier commodity like rice or drinking water, the online supermarket is quite convenient, and therefore, for example, for the shopping weak such as the elderly and the like, the online shopping is a beneficial purchasing method.

In order to carry out the shopping in the online supermarket, the customer generally accesses the site of the online supermarket through the internet from a customer terminal such as a PC or a mobile phone and the like arranged in the residence, and the ordering of the commodity is carried out by the customer himself. The store receiving the ordering purchases such a system delivering the ordered commodity to the residence of the customer on the same day or later. However, as accessing the site of the online supermarket by using the customer terminal such as the personal computer (hereinafter, called as “PC”) and the like can be carried out needing certain knowledge, the situation that the customer who is not quite accustomed to the use of the PC and the like cannot access the site of the online supermarket exists. In addition, the customer who does not have the customer terminal such as the PC and the like cannot utilize the online supermarket.

Therefore, in recent years, there is a service such that, for a customer who is difficult to carry out the ordering from the customer terminal or cannot carry out the ordering from the customer terminal, a store staff (salesclerk or part-time employment and the like) regularly visits residences of the customer which hopes a visit from the store staff, and the store staff receives the order of the customer at the residence of the customer, this service is so called “order-taking”.

About the order-taking, for example, commodity information and a image (hereinafter, calling such a terminal as “order-taker terminal”) used as the commodity information and the image for the online supermarket are preinstalled in a tablet computer terminal, the order-taker terminal is enabled to display the information and the image of the commodity in the residence of each customer, and the staff operates the order-taker terminal to receive the ordering while inquiring the expectation of the customer. Afterwards, when the ordering of all the wanted commodities is ended, the staff sends commodity data receiving the ordering to an online supermarket server in a wireless manner to end the ordering.

### BRIEF DESCRIPTION OF THE DRAWINGS

FIG. 1 is a diagram illustrating an overall system of the present embodiment;

FIG. 2 is a block diagram of a store server;

FIG. 3 is a memory map of the store server;

FIG. 4 is a block diagram of a POS terminal;

FIG. 5 is a flow chart illustrating the processing of the store server;

FIG. 6 is a flow chart illustrating the processing of the POS terminal;

FIG. 7 is a block diagram of an online supermarket server;

FIG. 8 is a memory map of the online supermarket server;

FIG. 9 is a flow chart illustrating the processing of the online supermarket server;

FIG. 10 is a diagram illustrating an initial screen of a customer terminal;

FIG. 11 is a block diagram of an online supermarket management server;

FIG. 12 is a memory map of the online supermarket management server;

FIG. 13 is a flow chart illustrating the processing of the online supermarket management server;

FIG. 14 is a block diagram of an order-taker terminal;

FIG. 15 is a memory map of the order-taker terminal;

FIG. 16 is a functional block diagram of the order-taker terminal;

FIG. 17 is a block diagram of a portable printer;

FIG. 18 is a flow chart illustrating the processing of the order-taker terminal;

FIG. 19 is a diagram illustrating an initial screen of the order-taker terminal;

FIG. 20 is a diagram illustrating an ordering screen of the order-taker terminal;

FIG. 21 is a diagram illustrating a screen after the ordering of the order-taker terminal is listed;

FIG. 22 is a diagram illustrating an ordering inexistence screen of the order-taker terminal;

FIG. 23 is a flow chart illustrating the processing of the portable printer;

FIG. 24-1 is a diagram of a customer-oriented bill printed and output from the portable printer; and

FIG. 24-2 is a diagram of a store reservation-oriented bill printed and output from the portable printer.

### DETAILED DESCRIPTION

In accordance with an embodiment, a portable information processing apparatus includes a display configured to display information, a sending unit configured to send the information to an exterior, a commodity display unit configured to display multiple pieces of commodity information on the display, a designated commodity storage unit configured to store the information of a designated commodity in displayed commodities, an order inexistence designating unit configured to designate ordering inexistence and a printing information output unit configured to send the information of the ordering inexistence as printing information from the sending unit to an external printing apparatus in a situation that the ordering inexistence is designated by the ordering inexistence designating unit.

In accordance with the embodiment, a carrying-oriented information input system includes a display configured to display information, a sending unit configured to send the information to an exterior, a commodity display unit configured to display multiple pieces of commodity information on the display, a designated commodity storage unit configured to store the information of a designated commodity in displayed commodities, an order inexistence designating unit configured to designate ordering inexistence, a printing information output unit configured to send the information of the ordering inexistence as printing information from the sending unit to an external printing apparatus in a situation that the ordering inexistence is designated by the ordering inexistence designating unit and a portable printing apparatus including a receiving unit, wherein the portable printing apparatus includes a bill issuing unit configured to issue a confirmation bill on which printing information is printed in a situation that the receiving unit receives the printing information of ordering inexistence.

In accordance with the embodiment, a method includes displaying multiple pieces of commodity information on a display, storing the information of a designated commodity in displayed commodities, designating ordering inexistence and sending the information of the ordering inexistence as printing information to an external printing apparatus in a situation that the ordering inexistence is designated.

The information processing apparatus, the carrying-oriented information input system and the program, to which the embodiment of the present invention relates, are described in detail with reference to drawings. In addition, the present invention is not limited to the embodiment.

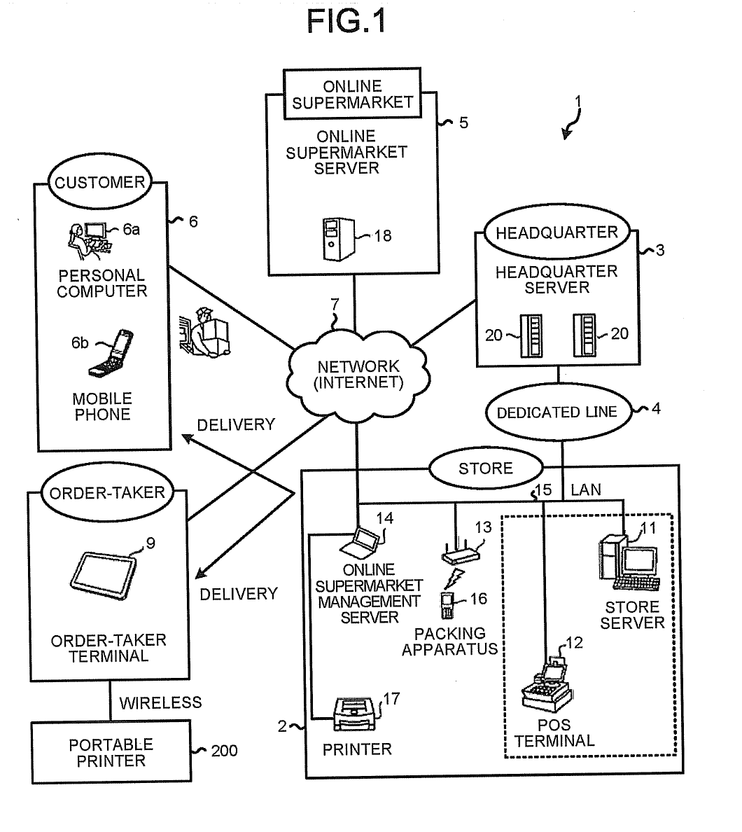

FIG. 1 is a diagram illustrating an overall system 1 of the present embodiment. In the overall system 1 in FIG. 1, a store system 2 is connected with a headquarters system 3 by using a dedicated line 4. In addition, the store system 2 is connected with an online supermarket system 5 through an internet 7. In addition, the online supermarket system 5 is connected with a customer terminal 6 (such as a personal computer 6a or a mobile phone 6b) through the internet 7.

The online supermarket system 5 is connected with a order-taker terminal 9 through internet 7.

The headquarters system 3 arranged in a headquarters comprises a headquarters server 20. The headquarters server 20 comprises a customer master file (not shown in figures) managing customer information (for example, the name, the age, the address, the gender, the birthday, the purchase history, the point number, the customer rank and the like of the customer) for each customer, and a commodity master file (not shown in the figures) storing the commodity information (commodity code, commodity name, price, attribute and the like) of each store for each commodity. The headquarters server 20 sends the customer information of the customer master file and the commodity information of the commodity master file to a store server 11 of each store through the dedicated line 4. In more detail, the headquarters server 20 sends the customer information according to the expectation from the store server 11. In addition, the headquarters server 20 enables the commodity information of the commodity master file (referring to FIG. 3) of the store server 11 of each store to be always the newest information by sending the updated commodity information to all the stores or the consistent store when the commodity information is updated each time.

The store system 2 arranged in each store is described. The store server 11, a plurality of POS (Point Of Sales) terminals 12 and an online supermarket management server 14 are mainly arranged in the store system 2, and they are mutually connected through an LAN (Local Area Network) 15.

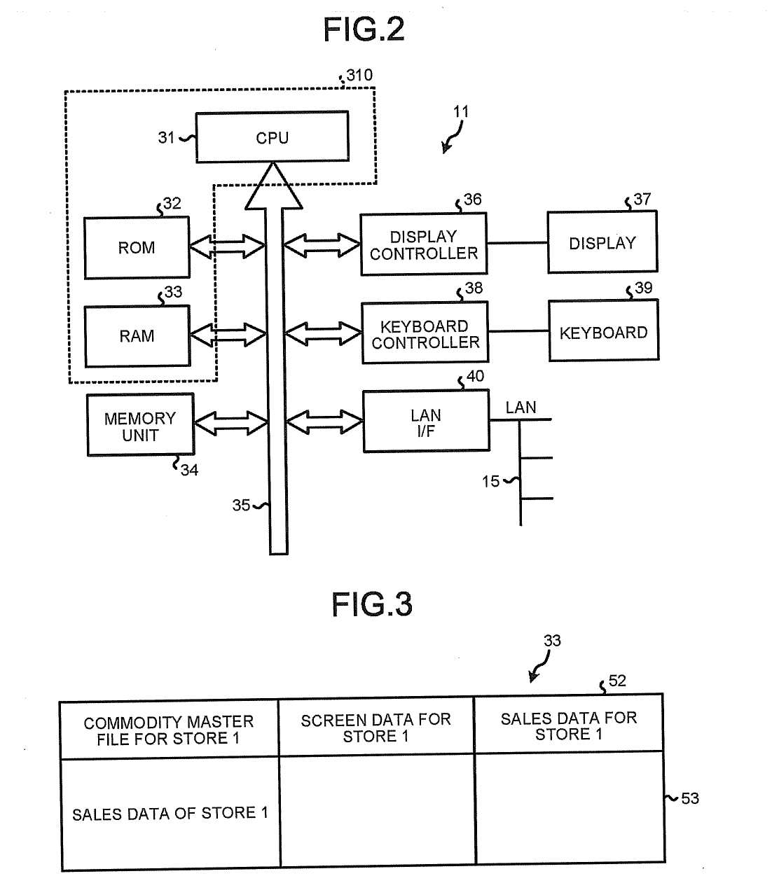

FIG. 2 is a block diagram illustrating the electric connection of hardware of the store server 11. As shown in FIG. 2, the store server 11 comprises a CPU (Central Processing Unit) 31 constituting a control main body, an ROM (Read Only Memory) 32 storing various programs, an RAM (Random Access Memory) 33 developing various data, a memory unit 34 such as an HDD and the like storing the various programs, and the like. The CPU 31, the ROM 32, the RAM 33 and the memory unit 34 are mutually connected through a data bus 35. The CPU 31, the ROM 32 and the RAM 33 constitute a control unit 310. That is, the control unit 310 executes control processing by acting according to the program stored by the CPU 31 in the ROM 32 or the memory unit 34.

The store server 11 comprises a display 37 and a keyboard 39. The display 37 is connected with the data bus 35 through a display controller 36. The keyboard 39 is connected with the data bus 35 through a keyboard controller 38. In addition, an LAN I/F (Interface) 40 connected with the LAN 15 is connected to the data bus 35.

FIG. 3 is a schematic diagram illustrating a memory map of the RAM 33 of the store server 11. As shown in FIG. 3, the RAM 33 comprises a commodity master file storage unit 52 storing the commodity master file sent from the headquarters server 20 and comprising the commodity code, the commodity name, the commodity price and the like of the commodity of the store, and a sales information storage unit 53 summarily managing sales information in the store.

In the store system 2, the plurality of POS terminals 12, an indoor antenna 13 receiving a signal from a portable terminal 16 used when the commodity collected from the store according to an ordered commodity list accepted in an online supermarket server 18 is boxed (packed) for each customer, and the online supermarket management server 14 are respectively connected with the store server 11 through the LAN 15. In addition, a printer 17 printing a delivery bill and the like is connected to the online supermarket management server 14.

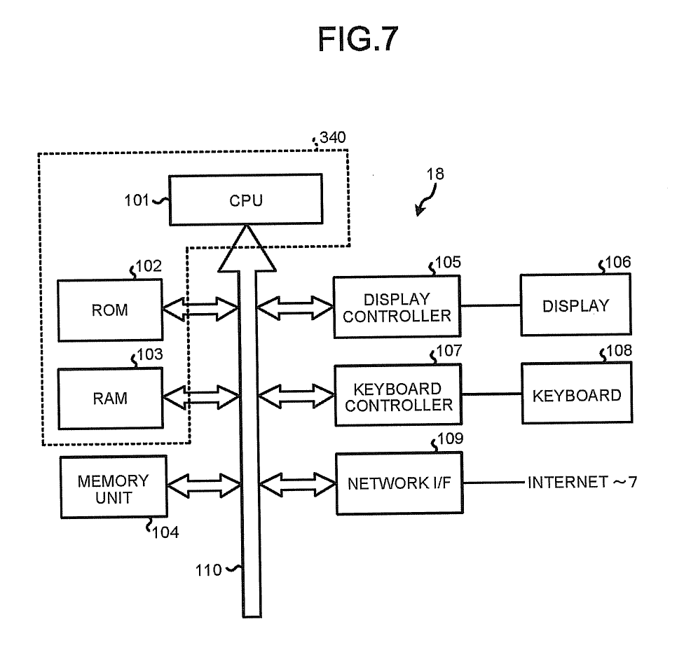

The store server 11 periodically sends the commodity information of the commodity master file sent form the headquarters server 20 and stored in the commodity master file storage unit 52 of the store server 11 to the online supermarket server 18. Therefore, the newest information of the commodity master file is always stored in an RAM 103 (referring to FIG. 7) of the online supermarket server 18.

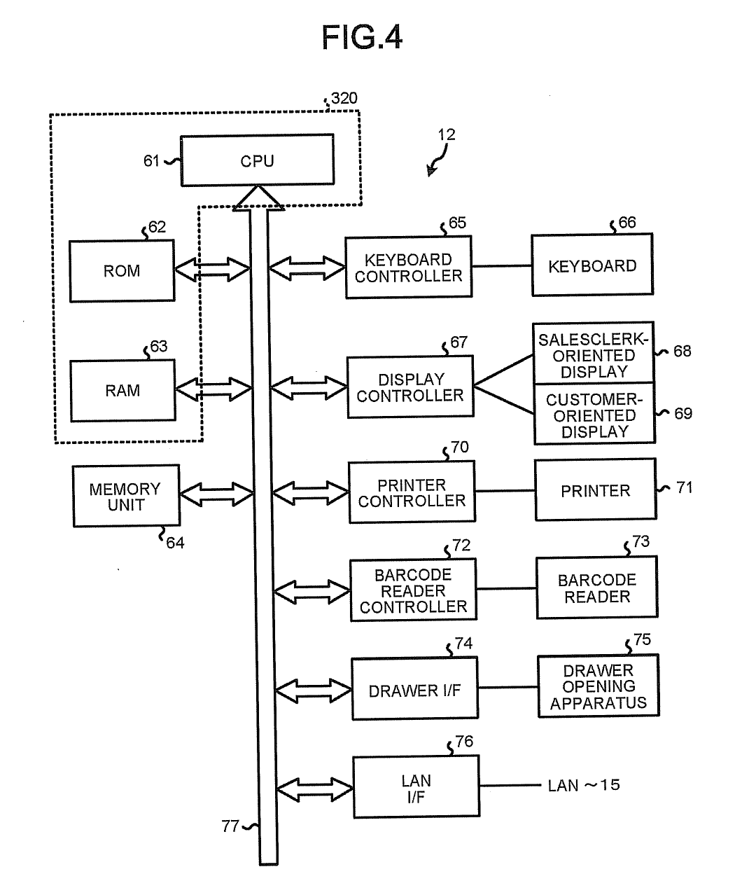

FIG. 4 is a block diagram illustrating the electric connection of hardware of the POS terminal 12. As shown in FIG. 4, the POS terminal 12 subjected to LAN connection with the store server 11 arranged in each store comprises a CPU 61 constituting the control main body, an ROM 62 storing the various programs, an RAM 63 developing the various data, and a memory unit 64 such as the HDD and the like storing the various programs. The CPU 61, the ROM 62, the RAM 63 and the memory unit 64 are mutually connected through a data bus 77. The CPU 61, the ROM 62 and the RAM 63 constitute a control unit 320. That is, the control unit 320 executes the control processing by acting according to the program stored by the CPU 61 in the ROM 62 or the memory unit 64.

The POS terminal 12 comprises a keyboard 66, a salesclerk-oriented display 68, a customer-oriented display 69, a receipt printer 71, a bar code reader 73 and a drawer opening apparatus 75 opening a drawer storing currency. The keyboard 66 is connected with the data bus 77 through a keyboard controller 65. The salesclerk-oriented display 68 and the customer-oriented display 69 are connected with the data bus 77 through a display controller 67. The receipt printer 71 is connected with the data bus 77 through a printer controller 70. The bar code reader 73 is connected with the data bus 77 through a bar code read controller 72. The drawer opening apparatus 75 is connected with the data bus 77 through a drawer I/F 74. In addition, an LAN I/F 76 connected with the LAN 15 is connected to the data bus 77.

The general outline of the processing in the store server 11 and the POS terminal 12 is described.

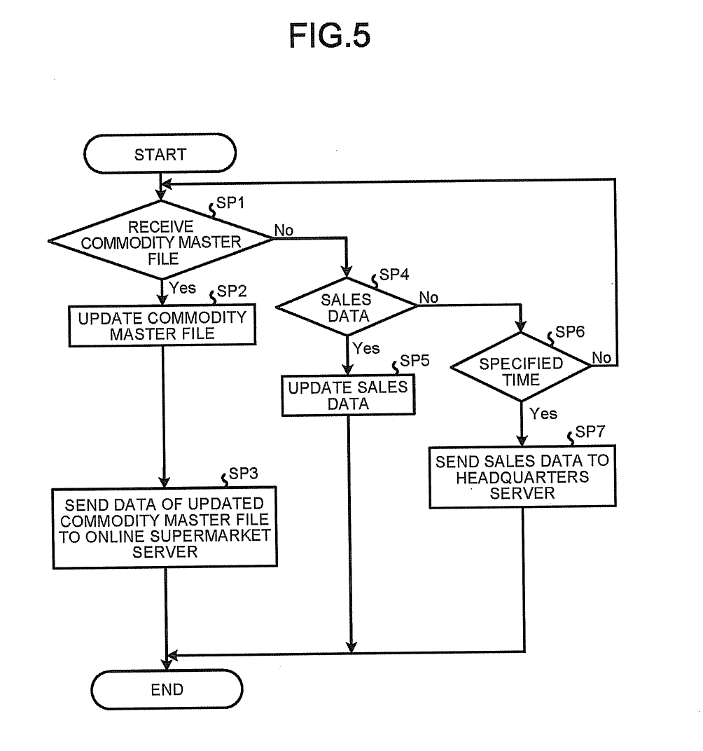

First, the main processing executed by the control unit 310 of the store server 11 is described with reference to a flow chart in FIG. 5. As shown in FIG. 5, the control unit 310 judges whether or not the data of the commodity master file are received from the headquarters server 20 (ACT SP1), judges whether or not sales data are received from any one of the plurality of POS terminals 12 (ACT SP4), and judges whether or not a specified time reaches (ACT SP6).

The control unit 310 updates the data of the commodity master file stored in the commodity master file storage unit 52 of the store server 11 (ACT SP2) in the situation that the data of the commodity master file are received from the headquarters server 20 (Yes in ACT SP1). Afterwards, the control unit 310 sends the updated commodity master file to the online supermarket server 18 through the LAN 15 and the internet 7 (ACT SP3). In addition, the control unit 310, for example, can also send the updated commodity master file to the online supermarket server 18 through the LAN 15 and the internet 7 in the situation that the commodity master file is individually updated in the store due to the sales price change and the like of special sale.

The control unit 310 updates the sales data stored in the sales information storage unit 53 of the store server 11 (ACT SP5) in the situation that the sales data are received from any one of the plurality of POS terminals 12 (No in ACT SP1; Yes in ACT SP4).

The control unit 310 sends the sales data of the store stored in the sales information storage unit 53 to the headquarters server 20 (ACT SP7) in the situation that the specified time is judged to reach (No in ACT SP4; Yes in ACT SP6). If the specified time does not reach (No in ACT SP6), the control unit 310 waits until any one of the data is received or the specific time reaches.

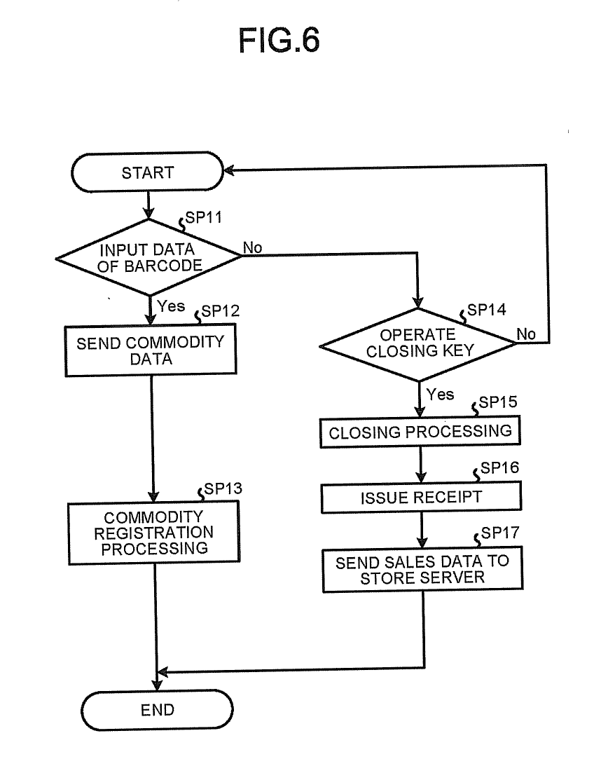

The main processing executed by the control unit 320 of the POS terminal 12 is described with reference to a flow chart in FIG. 6. As shown in FIG. 6, the control unit 320 judges whether or not the data of a bar code are input from the bar code reader 73 (ACT SP11), and judges whether or not an closing key is operated (ACT SP14).

In the situation that the data of the bar code are judged to be input from the bar code reader 73 (Yes in ACT SP11), the control unit 320 receives the commodity information of the commodity from the commodity master file stored in the store server 11 (ACT SP12) and executes commodity registration processing (ACT SP13). The commodity registration processing means that the commodity information of the commodity of which bar code is input is stored in a temporary buffer and the like.

In the situation that the closing key is judged to be operated (No in ACT SP11; Yes in ACT SP14), the control unit 320 executes, the closing processing of, for example, calculating a total amount (ACT SP15), and issues a receipt on which the commodity information read out from the temporary buffer or the total amount and the like are printed (ACT SP16). Subsequently, the control unit 320 sends stored commodity registration processing data to the store server 11 as the sales data (ACT SP17). When the data of the bar code are not input and the closing key is also not operated (No in ACT SP14), it waits until any one of that the data of the bar code are input or the closing key is operated.

The control unit 310 of the store server 11 receiving the commodity registration processing data executes the processing in ACT SP5 described in FIG. 5, and updates the data of the sales information storage unit 53.

A portion of the sales manner of a so-called online supermarket supporting to sell the commodity sold in the store through the internet 7 is described. In the online supermarket, when the ordering of commodity purchase is accepted from the customer through the internet 7, the consistent commodities in the store are collected (picked) from the store, the collected commodities are boxed (packed), subsequently, they are delivered to the residence of each customer, and the online supermarket is utilized in such a manner.

As the portion of the sales manner supporting the called online supermarket, it is equipped with the online supermarket management server 14 of the store system 2 and the online supermarket server 18 of the online supermarket system 5.

First, the online supermarket server 18 of the online supermarket system 5 is described. The online supermarket server 18 is a server apparatus for providing an online supermarket service of selling all or a portion of the commodities sold in the store through the internet 7. As shown in FIG. 1, the online supermarket server 18 is connected with the online supermarket management server 14 of the store system 2 through the internet 7.

FIG. 7 is a block diagram illustrating the electric connection of hardware of the online supermarket server 18, and in a data bus 110, a CPU 101 constituting the control main body, an ROM 102 storing the various programs, the RAM 103 developing the various data, and a memory unit 104 such as the HDD and the like storing the various programs are included. The CPU 101, the ROM 102, the RAM 103 and the memory unit 104 are mutually connected through the data bus 110. The CPU 101, the ROM 102 and the RAM 103 constitute a control unit 340. That is, the control unit 340 executes the control processing by acting according to the program stored by the CPU 101 in the ROM 102 or the memory unit 104.

The online supermarket server 18 comprises a display 106 and a keyboard 108. The display 106 is connected with the data bus 110 through a display controller 105. The keyboard 108 is connected with the data bus 110 through a keyboard controller 107. In addition, the online supermarket server 18 is connected with the internet 7 through a network I/F 109.

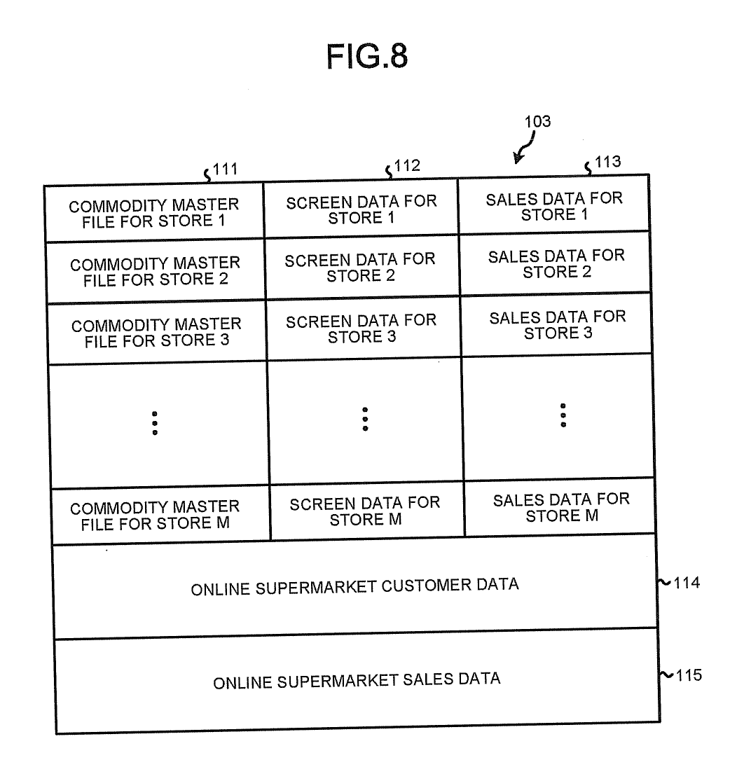

FIG. 8 is a schematic diagram illustrating a memory map of the RAM 103 of the online supermarket server 18. As shown in FIG. 8, the RAM 103 comprises each store commodity master file storage unit 111 storing the commodity master file of all store for each store, each store screen data storage unit 112 storing the screen data of all the store, which are displayed on the customer terminal 6 for each store, and a store-oriented sales data storage unit 113 storing the sales data of all the store in the online supermarket for each store. In addition, the RAM 103 comprises an online supermarket customer data storage unit 114 storing customer data such as the name, the address, the login ID, the password and the like of all the customers registered in the online supermarket server 18 by a user for each customer, and an online supermarket sales data storage unit 115 storing all the sales data in the online supermarket.

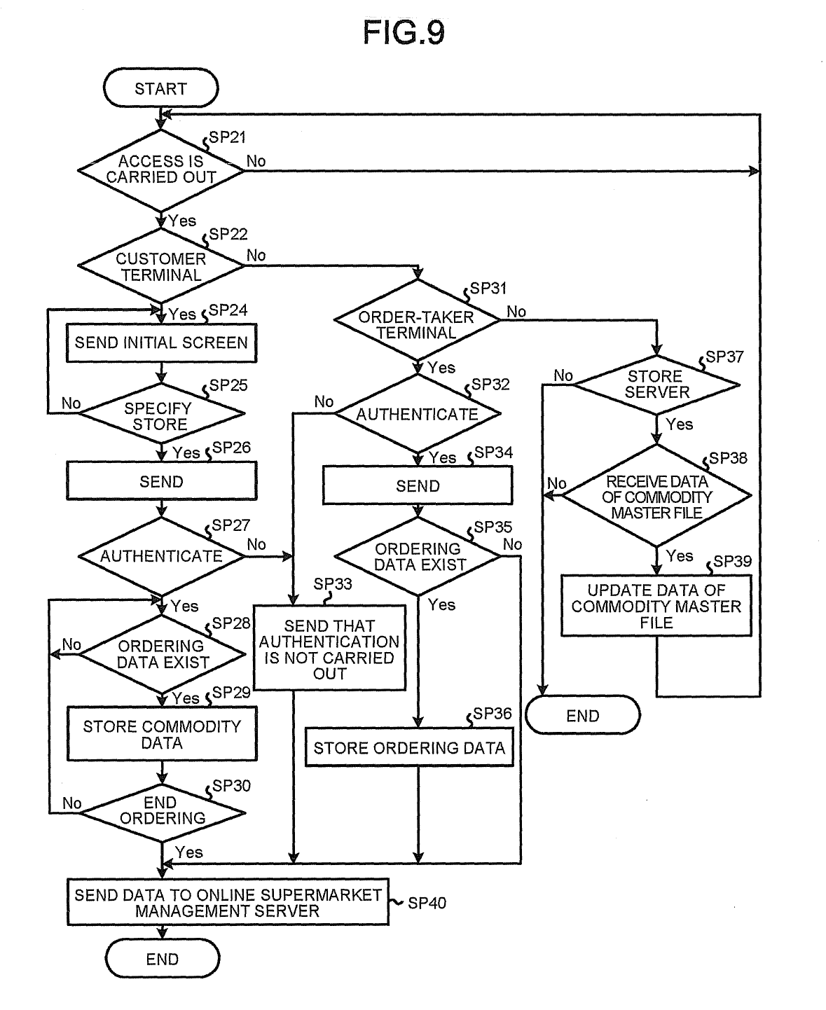

The processing of the online supermarket server 18 is described by using FIG. 9. The control unit 340 executes the following control. The control unit 340 judges whether or not the online supermarket server 18 is accessed (ACT SP21), and if the access is judged to be carried out (Yes in ACT SP21), the control unit 340 judges whether or not it is the access from the customer terminal 6 (ACT SP22), judges whether or not it is the access from the order-taker terminal 9 (ACT SP31), and judges whether or not it is the access from the store server 11 (ACT SP37). In the situation that the access to the online supermarket server 18 does not exist (No in ACT SP21), the control unit 340 waits until the access to the online supermarket server 18 exists.

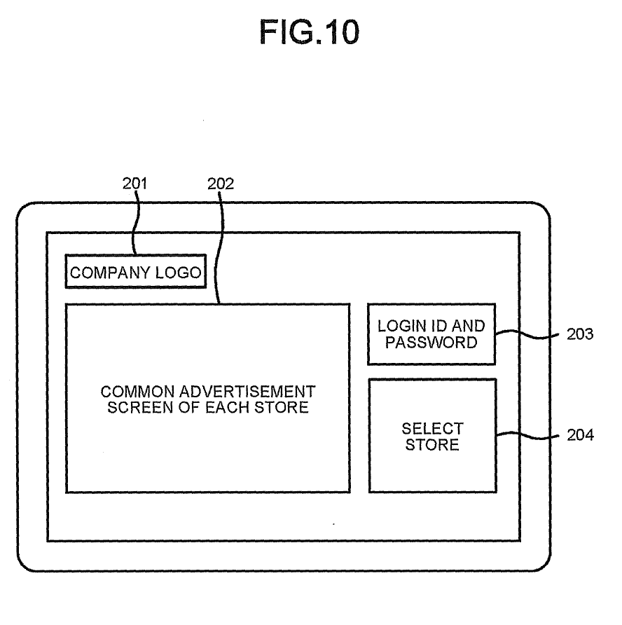

If the access from the customer terminal 6 exists (Yes in ACT SP22), the control unit 340 sends an initial screen of the online supermarket to the customer terminal 6 (ACT SP 24). The initial screen sent by the control unit 340, for example, is displayed on a display of the customer terminal 6 like FIG. 10. In the initial screen of the customer terminal 6 in FIG. 10, on the display of the customer terminal 6, a logo space 201 showing the logo of a company running the online supermarket, an advertisement bar 202 showing the common advertisement screen of all the stores, a bar 203 inputting the login ID or the password, a store selecting bar 204 selecting the store, and the like, are shown.

The control unit 340 judges whether or not the customer designates the store from which the commodity is to be purchased (ACT SP25), if the customer designates the store from which the commodity is to be purchased (Yes in ACT SP25), the control unit 340 reads the store-oriented screen of the designated store out from each store screen data storage unit 112, reads the commodity information, the commodity price, the commodity image and the like of the store out from the commodity master file stored in each store commodity master file storage unit 111, and sends them to the customer (ACT SP26). The control unit 340 displays the initial screen until the store is designated (No in ACT SP25). Next, the control unit 340 judges whether or not the customer is authenticated (ACT SP27). The control unit 340 confirms whether or not the customer is authenticated by confirming whether or not the login ID and the password input from the customer terminal 6 by the customer are consistent with the login ID and the password stored in the online supermarket customer data storage unit 114 of the RAM 103 and previously registered from the customer. If the customer is authenticated (Yes in ACT SP27), the customer can carry out the ordering from the customer terminal 6, and therefore, the control unit 340 next judges whether or not the customer carries out the ordering (ACT SP28). In the situation that the customer is not authenticated (No in ACT SP27), the information that the customer is not authenticated is sent to the customer terminal 6.

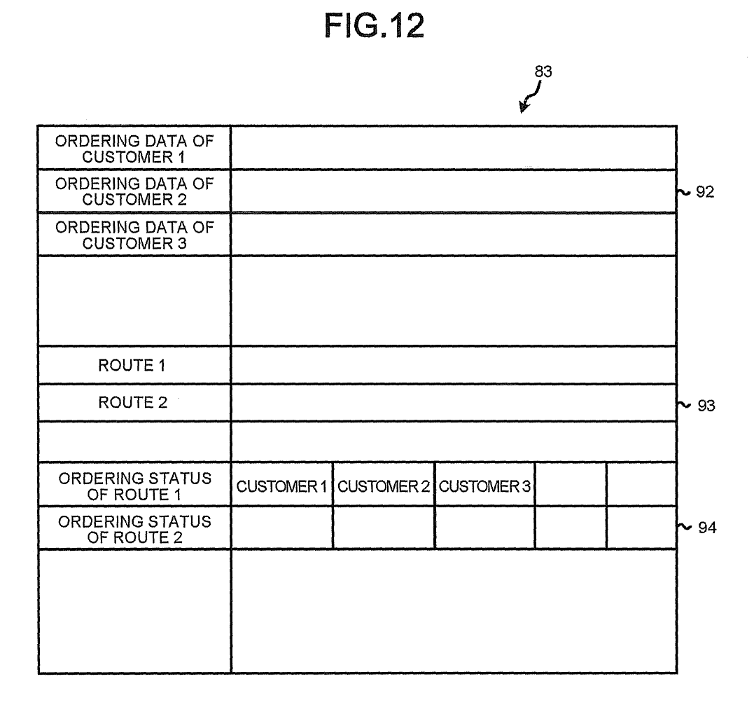

The control unit 340 waits until the ordering is carried out from the customer (No in ACT SP28), and in the situation that the ordering is carried out from the customer (Yes in ACT SP28), it reads the commodity information and the commodity price of the commodity out from each store commodity master file storage unit 111 of the online supermarket server 18, and stores the commodity information and the commodity price of the commodity in the store-oriented sales data storage unit 113 of the consistent store for each customer (ACT SP29). Next, the control unit 340 judges whether or not the ordering in the online supermarket is ended (ACT SP30), and it returns to ACT SP28 to accept the further ordering if the ordering in the online supermarket is not ended (No in ACT SP30). If the ordering is ended (Yes in ACT SP30), the control unit 340 sends the information of all the commodities ordered by the customer, which is stored in the store-oriented sales data storage unit 113, to the online supermarket management server 14 together with the login ID of the customer through the internet 7 (ACT SP40). Afterwards, the control unit 340 updates the sales information in the online supermarket, which is stored in the online supermarket sales data storage unit 115. In the online supermarket management server 14, the sales data of the customer in the online supermarket server 18, which are received through the internet 7, are stored in each customer ordering data area 92 (referring to FIG. 12) for each customer.

In the situation that the access is the access from the order-taker terminal 9 (No in ACT SP22; Yes in ACT SP31), the control unit 340 confirms whether or not the login ID and the password input from the order-taker terminal 9 are consistent with the login ID and the password stored in the online supermarket customer data storage unit 114 of the RAM 103 and previously registered from the customer, and carries out authentication if they are consistent. Afterwards, if the customer is authenticated (Yes in ACT SP32), the control unit 340 sends the situation that the customer is authenticated to the order-taker terminal 9 (ACT SP34). Afterwards, the control unit 340 judges whether or not ordering data are sent from the order-taker terminal 9 (ACT SP35), if the ordering data exist (Yes in ACT SP35), it stores the ordering data (ACT SP36) and sends ordering date to the online supermarket management server 14. In addition, in the situation that the authentication cannot be carried out in ACT SP32 (No in ACT SP32), the control unit 340 sends the information that the authentication is not carried out to the order-taker terminal 9 (ACT SP33).

In the situation that the access is the access from the store server 11 (No in ACT SP31; Yes in ACT SP37), the control unit 340 judges whether or not the data of the commodity master file are received from the store server 11 (ACT SP38), and in the situation that the data of the commodity master file are received (Yes in ACT SP38), the control unit 340 updates the data of the commodity master file stored in each store commodity master file storage unit 111 of the consistent store and uses the updated data of the commodity master file as the newest data of the commodity master file (ACT SP39). In the situation that the access is not the access from any one of the order-taker terminal 9 and the store server 11 (No in ACT SP37) or in the situation that the data except the data of the commodity master file are received in ACT SP36 (No in ACT SP38:), the control unit 340 executes other processing corresponding to the data to end.

The online supermarket management server 14 of the store system 2 is described. The online supermarket management server 14 receives the ordered commodity list including the ordered commodity accepted in the online supermarket server 18 from the online supermarket server 18, and furthermore, sends a signal for outputting the confirmation or delivery bill when the commodity ordered in the online supermarket is to be boxed (packed). In addition, the management on the various data needed for providing the online supermarket service is also carried out. As shown in FIG. 1, the online supermarket management server 14 is arranged in each store, and is connected with the store server 11 through the LAN 15.

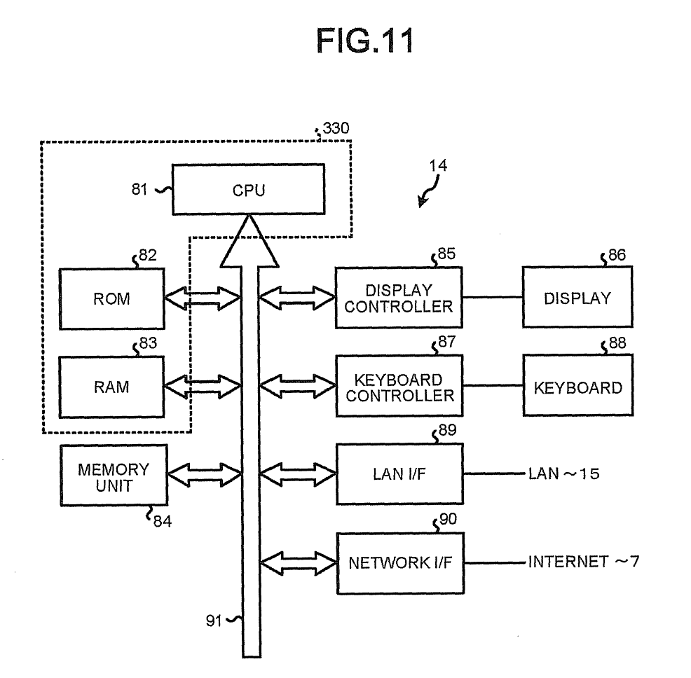

FIG. 11 is a block diagram illustrating the electric connection of hardware of the online supermarket management server 14. As shown in FIG. 11, the online supermarket management server 14 comprises a CPU 81 constituting the control main body, an ROM 82 storing the various programs, an RAM 83 developing the various data, and a memory unit 84 such as the HDD and the like storing the various programs. The CPU 81, the ROM 82, the RAM 83 and the memory unit 84 are mutually connected through a data bus 91. The CPU 81, the ROM 82 and the RAM 83 constitute a control unit 330. That is, the control unit 330 executes the control processing by acting according to the program stored by the CPU 81 in the ROM 82 or the memory unit 84. In addition, the online supermarket management server 14 comprises a display 86 and a keyboard 88. The display 86 is connected with the data bus 91 through a display controller 85. The keyboard 88 is connected with the data bus 91 through a keyboard controller 87. In addition, the data bus 91 is also connected with an LAN I/F 89 connecting the online supermarket management server 14 to the LAN 15. In addition, the data bus 91 is also connected with a network I/F 90 connecting the online supermarket management server 14 to the internet 7.

The indoor antenna 13 is connected with the online supermarket management server 14 through the LAN 15, and when the bar code of the commodity to be boxed (packed) by using the portable terminal 16 is read, the read commodity information is sent to the online supermarket management server 14 through the indoor antenna 13 in a wireless manner.

FIG. 12 is a schematic diagram illustrating a memory map of the RAM 83 of the online supermarket management server 14, and the memory map comprises each customer ordering data area 92 storing the ordering data (commodity code, commodity name, commodity price and the like) ordered in the online supermarket from the customer terminal 6 for each customer, an area 93 storing a plurality of routes for visiting of order-taking, and an area 94 storing a order-taking result in each route for each route, and furthermore, for each customer.

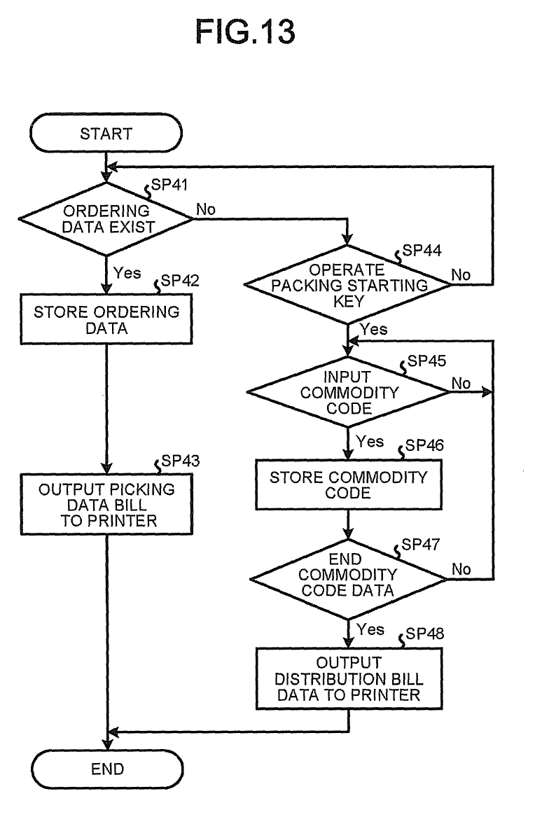

The processing of the online supermarket management server 14 is described by using FIG. 13. The control unit 330 executes the following control. Whether or not the ordering data sent in ACT SP40 in FIG. 9 and taking the customer as a unit are received is judged (ACT SP41), and whether or not a starting key carrying out packing for the portable terminal 16 is operated is judged (ACT SP44).

In the situation that the ordering data are judged to be received from the online supermarket server 18 using the customer as the unit (Yes in ACT SP41), the control unit 330 stores the ordering data in each customer ordering data area 92 of the RAM 83 for each customer (ACT SP42). Afterwards, according to the instruction of an operator, based on the ordering data for each customer, which are stored in each customer ordering data area 92, the control unit 330 outputs the information for printing a picking bill to the printer 17 (ACT SP43), and the picking bill is used for collecting (picking) the ordered commodity in the store. For each commodity, all the commodity information ordered by the customer is printed on the picking bill.

The salesclerk itinerates in the store to collect the ordered commodity while viewing the picking bill. The collected commodity is boxed (packed) by the salesclerk. At the time, the starting key carrying out the packing is operated from the portable terminal 16. In the situation that the received data are a signal denoting that the starting key carrying out the packing of the commodity is operated (Yes in ACT SP44), the control unit 330 judges whether or not the input of the commodity code exists through the indoor antenna 13 by reading the bar code of the commodity to be packed by using the portable terminal 16 (ACT SP45), and in the situation that the input of the commodity code exists (Yes in ACT SP45), the control unit 330 stores the input commodity code (ACT SP46). Afterwards, when the control unit 330 judges that the commodity codes of all the commodities stored in each customer ordering data area 92 of the customer are input (Yes in ACT SP47), the data of the ordered commodity are printed together with the input commodity information of all the commodities item by item and the bar code from the printer 17 and are output as the delivery bill (ACT SP48). The staff holds the delivery bill and the ordered commodity to go to the residence in which the ordering is carried out for delivering the commodity. In the situation that a starting signal carrying out the packing is not input (No in ACT SP44) or in the situation that the commodity code is not input (No in ACT SP45), the control unit 330 enables the processing to wait. In addition, the processing in ACT SP45 to ACT SP47 is executed until the commodity codes of all the commodities are input.

When the delivery bill is output from the printer 17 in ACT SP48, a delivery staff packs all the commodities subjected to the ordering, and then, delivers the packed commodities to the residence in which the ordering is carried out, for example, by using a delivery truck. When returning to the store after the completion of the delivery, about the delivered commodity, the delivery staff reads the bar code printed on the delivery bill after being printed and output in ACT SP48 by using the bar code reader 73 of the predetermined special POS terminal 12 for the online supermarket with a sequence the same as that of the input of the sales data of the commodity sold in the store, and inputs the data of the delivered commodity as the sales data. In this way, the sale in the online supermarket can be calculated as the sale of the store.

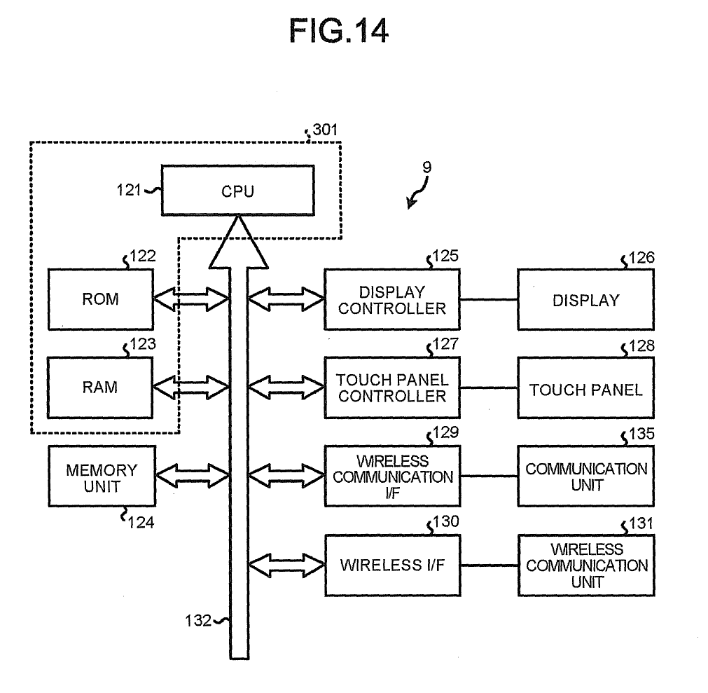

FIG. 14 is a block diagram illustrating the electric connection of hardware of the order-taker terminal 9 held when the staff of each store visits for order-taking. As shown in FIG. 14, the order-taker terminal 9 comprises a CPU 121 constituting the control main body, an ROM 122 storing the various programs, an RAM 123 developing the various data, and a memory unit 124 such as a flash memory and the like storing the various programs. The CPU 121, the ROM 122, the RAM 123 and the memory unit 124 are mutually connected through a data bus 132. The CPU 121, the ROM 122 and the RAM 123 constitute a control unit 301. That is, the control unit 301 executes the processing by acting according to the program stored by the CPU 121 in the ROM 122 or the memory unit 124. In addition, the order-taker terminal 9 comprises a display 126 and a touch panel 128. The display 126 is connected with the data bus 132 through a display controller 125. The touch panel 128 is connected with the data bus 132 through a touch panel controller 127. The touch panel 128 is constituted by a transparent component and is laminated on the display 126, by touching the touch panel 128 displayed at the position of a key and the like on the display 126, the signal corresponding to the key is output to the touch panel controller 127 from the touch panel 128. In addition, the data bus 91 is also connected with, for example, a communication unit 135 connected with the internet 7 by Wireless Fidelity in the wireless manner through a wireless I/F 129. In addition, the data bus 91 is also connected with, for example, a wireless communication unit 131 which can carry out wireless communication by a Bluetooth technology though an LAN I/F 130. The printing information is sent from the wireless communication unit 131 to a portable printer 200 in the wireless manner.

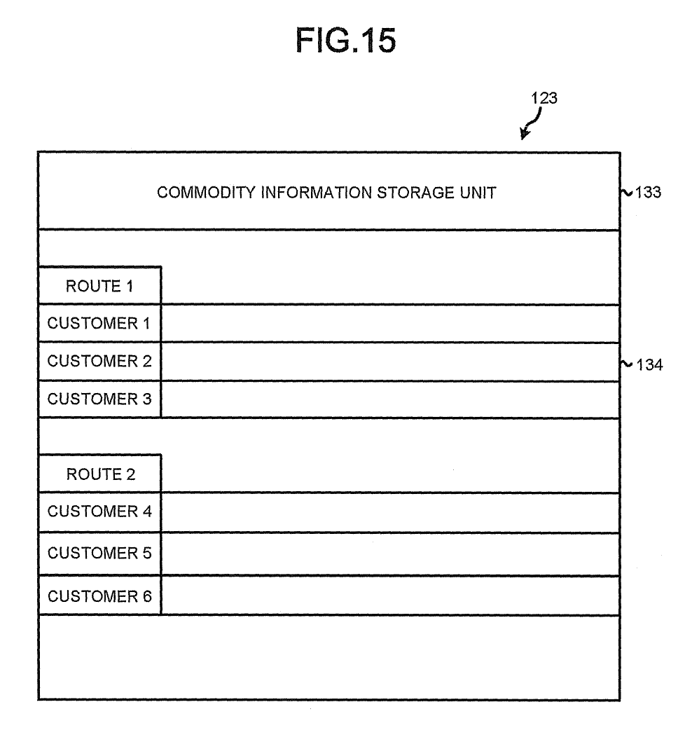

FIG. 15 is a schematic diagram illustrating a memory map of the RAM 123 of the order-taker terminal 9. In FIG. 15, the RAM 123 comprises a commodity information storage unit 133 and an order-taking result storage unit 134 storing the order-taking result. The commodity information, the commodity price, the commodity image and the like of the store, which are displayed on the order-taker terminal 9, are stored in the commodity information storage unit 133, for example, before visiting for order-taking, the commodity information of the store, and the position, the customer name and the like of the residence subjected to an itinerant route visit are sent to the order-taker terminal 9 from the online supermarket server 18 to be stored. Such sending is carried out by setting the order-taker terminal 9 in a set box arranged in the store and downloading from the online supermarket server 18.

The commodity information stored in the order-taker terminal 9 includes the information which is the same as the commodity information displayed on the customer terminal 6 of the customer in the online supermarket, when the staff for order-taking visits to the residence of the customer, the staff shows the screen of commodity information displayed on the order-taker terminal 9, operates the order-taker terminal 9 and inputs the commodity requested from a customer for the customer at the residence of the customer.

In the order-taking result storage unit 134 stores ordering information for each customer received the itinerant visit if there is order of the commodity, and stores the content that there is no order if there is no order of the commodity for each customer.

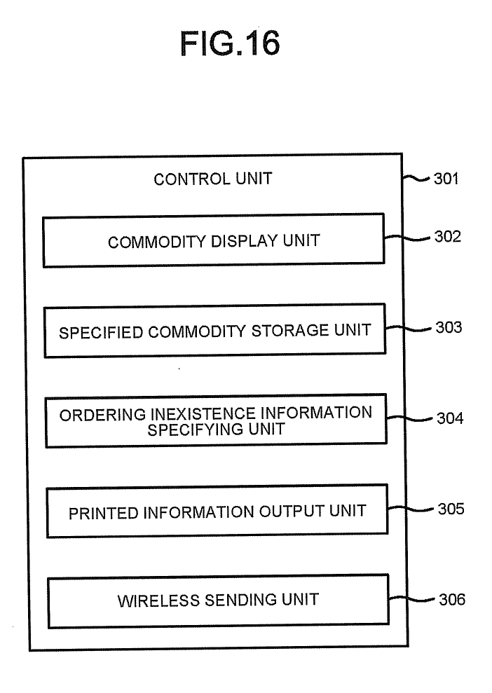

FIG. 16 illustrates a functional block diagram of the order-taker terminal 9. In FIG. 16, the control unit 301 enables a commodity display unit 302, a designated commodity storage unit 303, an ordering inexistence information designating unit 304, a printing information output unit 305 and a wireless sending unit 306 to function according to the various programs stored in the ROM 122 and the memory unit 124.

The commodity display unit 302 has a function of displaying the multiple pieces of commodity information on the display 126. The designated commodity storage unit 303 has a function of storing the designated commodity in the displayed commodities. The ordering inexistence information designating unit 304 has a function of designating the ordering inexistence. The printing information output unit 305 has a function of sending the information of the ordering inexistence from the sending unit to the external printing apparatus as the printing information in the situation that the ordering inexistence information designating unit 304 designates the ordering inexistence. The wireless sending unit 306 has a function of sending the commodity information designated by the designated commodity storage unit 303 to the exterior as the ordering information of the customer.

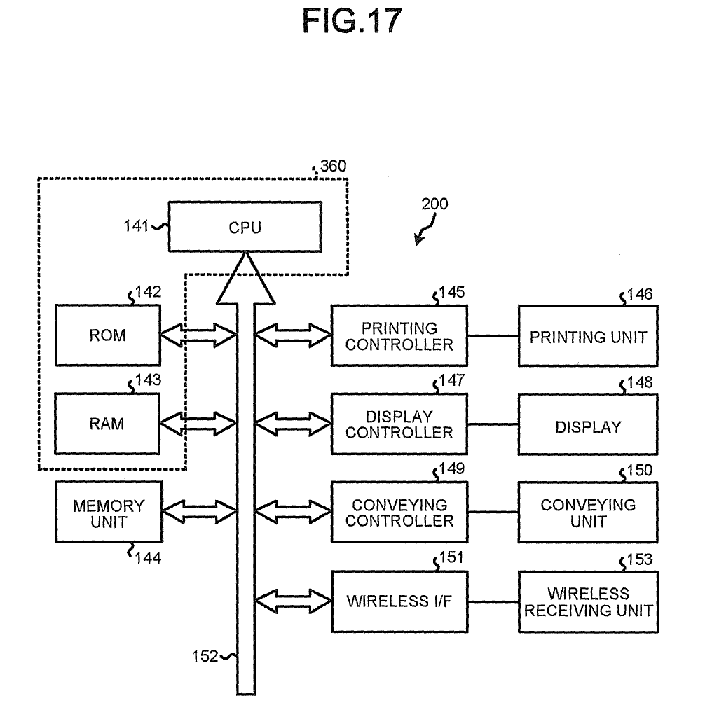

FIG. 17 is a block diagram illustrating the electric connection of hardware of the portable printer 200 subjected to wireless connection with the order-taker terminal 9. As shown in FIG. 17, the portable printer 200 comprises a CPU 141 constituting the control main body, an ROM 142 storing the various programs, an RAM 143 developing the various data, and a memory unit 144 such as the flash memory and the like storing the various programs. The CPU 141, the ROM 142, the RAM 143 and the memory unit 144 are mutually connected through the data bus 132. The CPU 141, the ROM 142 and the RAM 143 constitute a control unit 360. That is, the control unit 360 executes the control processing by acting according to the program stored by the CPU 141 in the ROM 142 and the memory unit 144. In addition, the portable printer 200 comprises a printing unit 146, a display 148 and a conveying unit 150. The printing unit 146 is connected with a data bus 152 through a printing controller 145. The display 148 is connected with the data bus 152 through a display controller 147. The conveying unit 150 is connected with the data bus 152 through a conveying controller 149.

An LAN I/F 151 connected with a wireless receiving unit 153 is connected to the data bus 152. The wireless receiving unit 153 receives the printing information subjected to wireless sending from the wireless communication unit 131 of order-taker terminal 9. The received printing information is printed, for example, on built-in roll paper by the printing unit 146.

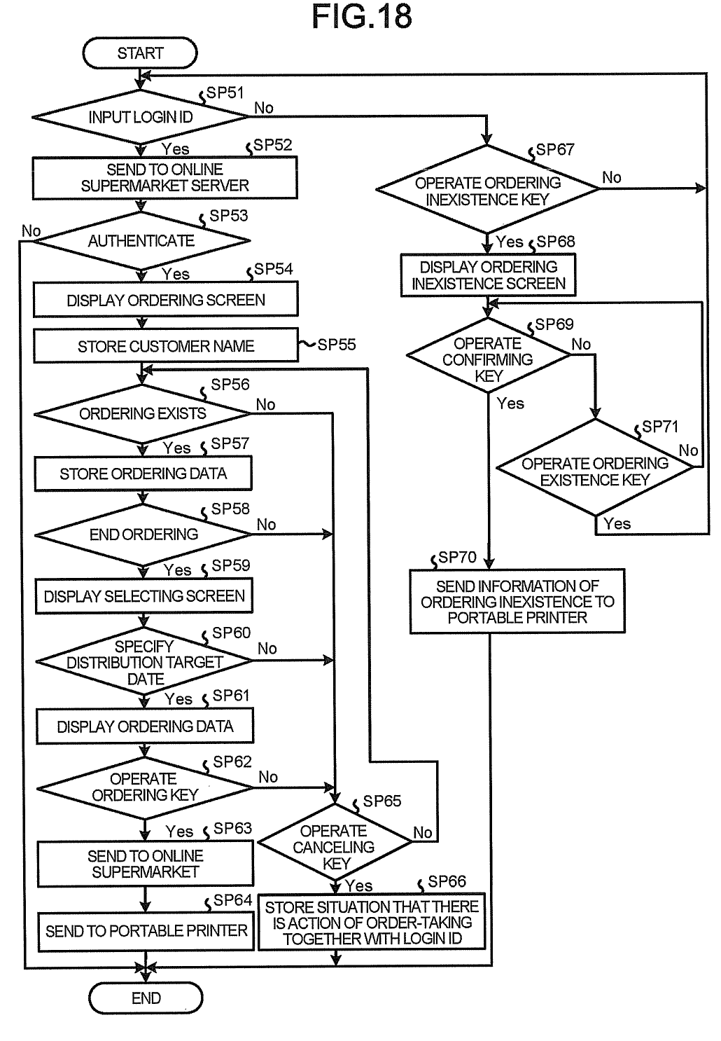

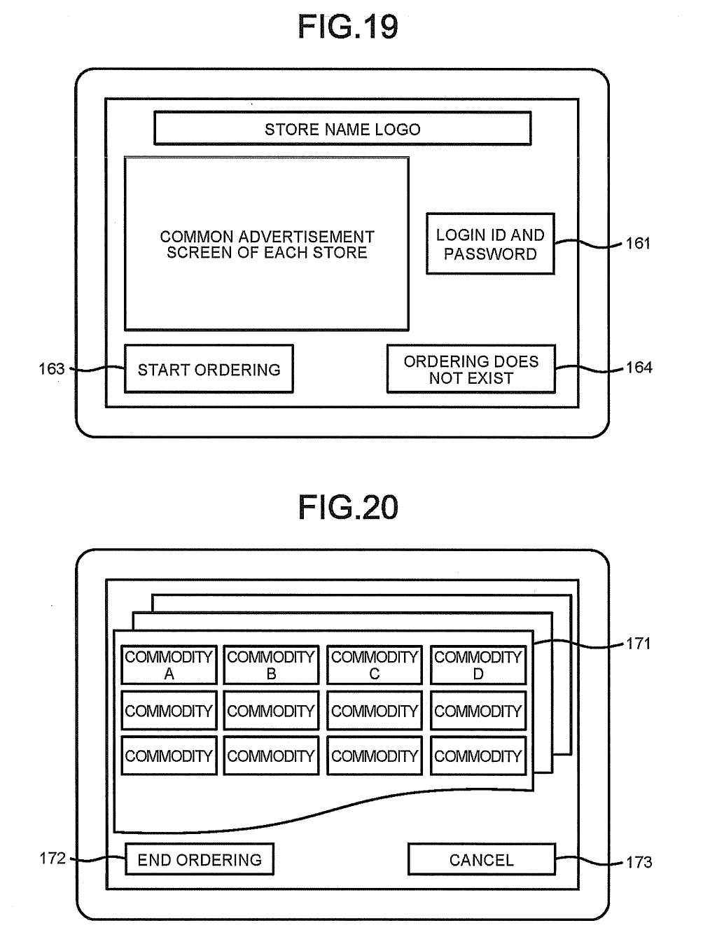

The processing of the order-taker terminal 9 used when the staff holds the order-taker terminal 9 to visit each residence is described by using FIG. 18. The control unit 301 executes the following control. The control unit 301 enables the order-taker terminal 9 to display, for example, a screen shown in FIG. 19 as the initial screen. FIG. 19 is an example of the initial screen of the order-taker terminal 9, a store name logo, the advertisement of the store of the order-taking, and the like, are displayed on the initial screen. In addition, an area 161 inputting the login ID and the password for determining the customer and receiving the authentication, an ordering starting key 163 inputting ordering start, an ordering inexistence key 164 inputting the ordering inexistence, and the like, are also displayed on the initial screen. In addition, the order-taker terminal 9 stores the information of the commodity in the commodity information storage unit 133 of the RAM 123. The commodity information in the commodity information storage unit 133 is stored by connecting the order-taker terminal 9 to the online supermarket server 18 in the store and being downloaded from each store commodity master file storage unit 111 of the online supermarket server 18.

The control unit 301 judges whether or not the login ID and the password for confirming the customer are input (ACT SP51), and judges whether or not the ordering inexistence key 164 is operated (ACT SP 67).

In the situation that the control unit 301 judges that the login ID and the password are input (Yes in ACT SP51), at the timing when the ordering starting key 163 is operated, the control unit 301 sends the login ID and the password from the communication unit 135 to the online supermarket server 18 (ACT SP52). The control unit 340 of the online supermarket server 18 checks the received login ID and password with the login ID and the password of the customer, which are stored in the online supermarket customer data storage unit 114 of the RAM 103, and judges whether or not they are consistent. If the received login ID and password are consistent with the login ID and the password of the customer, which are stored in the online supermarket customer data storage unit 114 of the RAM 103, the control unit 340 sends the situation that the login ID is authenticated to the order-taker terminal 9 (ACT SP32 and ACT SP34 in FIG. 9).

If the login ID is authenticated (Yes in ACT SP53), the control unit 301 enables the commodity display unit 302 to function, reads the commodity information out from the commodity information storage unit 133, displays an ordering screen on the display 148 (ACT SP54), and receives the customer name of the authenticated customer from the online supermarket server 18 and stores the customer name in the RAM 103 (ACT SP55). An example of the ordering screen of the order-taker terminal 9 is illustrated in FIG. 20. An ordering display unit 171 showing a plurality of commodities, an ordering ending key 172 ending the ordering, a canceling key 173 canceling the ordering, and the like, are displayed on the ordering screen. The customer selects the wanted commodity from the commodities displayed on the ordering display unit 171.

The staff of order-taking touches the touch panel 128 on the display 126 displaying the commodity selected by the customer to designate the commodity. By designating the commodity, the ordering processing is started. In the situation that the commodity is designated, and furthermore, the ordering is carried out (Yes in ACT SP56), the control unit 301 enables the designated commodity storage unit 303 to function, and stores the designated commodity information in the order-taking result storage unit 134 (ACT SP57). The control unit 301 repeats the processing to store all the commodity information wanted by the customer in the order-taking result storage unit 134.

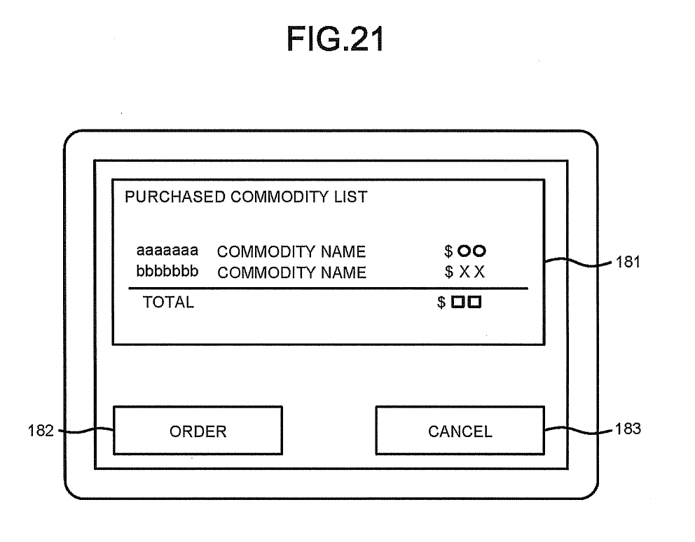

Afterwards, the control unit 301 displays an input screen for a delivery target date (ACT SP59) when the ordering ending key 172 is operated (Yes in ACT SP58). The delivery target date is included in the information downloaded in the order-taker terminal 9 from the online supermarket server 18. If the delivery target date is designated (Yes in ACT SP60), the control unit 301 lists and displays all the commodities subjected to the ordering (ACT SP61). An example of a screen after the commodities are listed is illustrated in FIG. 21. A list display unit 181 displaying the list of the input commodity according to the ordering of the customer, an ordering key 182 determining the ordering, a canceling key 183 canceling the ordering, and the like, are displayed on the screen. If the ordering key 182 is operated (Yes in ACT SP62), the control unit 301 enables the wireless sending unit 306 to function, and sends the detailed commodity information such as the commodity code, the commodity name, the commodity price and the like of the ordered commodity, which are stored in the order-taking result storage unit 134, together with route information, the login ID of the customer, a staff name and the like to the online supermarket server 18 from the communication unit 135 through the internet 7 by utilizing the wireless communication (ACT SP63). Afterwards, the control unit 301 sends the commodity information sent in ACT SP63, the customer name, the delivery target date and the like to the portable printer 200 from the wireless communication unit 131 as the printing information (ACT SP64). The portable printer 200 receives the commodity information by utilizing the wireless receiving unit 153, and prints and issues the bill from the printing unit 146.

The control unit 301 waits until the canceling key 183 is operated (No in ACT SP65), and if the canceling key 183 is operated (any one of No in ACT SP56, No in ACT SP58, No in ACT SP60 and No in ACT SP62; Yes in ACT SP65), the information denoting the situation that the order-taking is carried out but the ordering is not carried out together with the login ID is sent to the online supermarket server 18 from the communication unit 135 through the internet 7 by utilizing the wireless communication (ACT SP66). The control unit 340 of the online supermarket server 18 stores the sent data of the ordered commodity or the information denoting the situation that the order-taking is carried out but the ordering is not carried out in the online supermarket sales data storage unit 115.

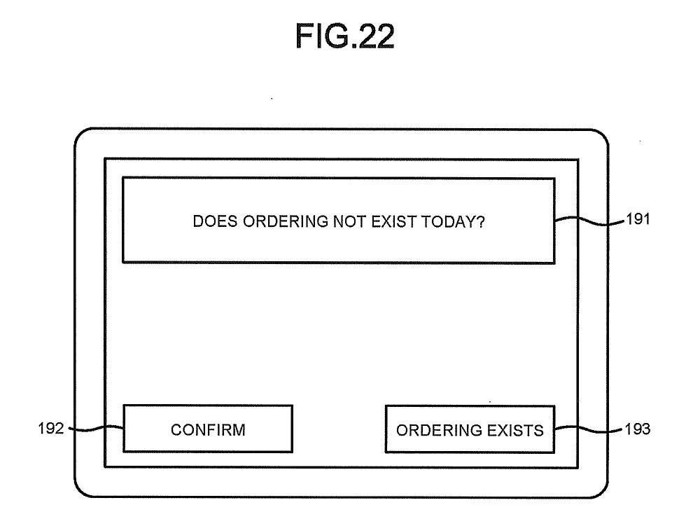

The time when the ordering inexistence key 164 is operated before the login ID and the password are input in the situation that commodity to be ordered does not exist is described. The waiting is carried out until the ordering inexistence key 164 in the initial screen in FIG. 19 is operated (No in ACT SP67), and when the ordering inexistence key 64 is operated, the control unit 301 enables the ordering inexistence information designating unit 304 to function, and judges whether or not the ordering inexistence key 164 is operated (No in ACT SP51; Yes in ACT SP67). Afterwards, an ordering inexistence screen (an example) as shown in FIG. 22 is displayed. In the screen in FIG. 22, a display unit 191 executing the display for confirming the ordering inexistence, an ordering inexistence confirming key 192 confirming ordering inexistence OK (confirming the ordering inexistence well), an ordering existence key 193 for starting the ordering, and the like, are illustrated.

The display of, for example, “does the ordering not exist today” is executed in the display unit 191 (ACT SP68), subsequently, when the confirming key 192 is operated (Yes in ACT SP69), the control unit 301 enables the printing information output unit 305 to function, and the order-taker terminal 9 sends the information of the ordering inexistence to the portable printer 200 from the wireless communication unit 131 as the printing information (ACT SP70). In addition, the control unit 301 returns to the initial screen when the ordering key 193 rather than the confirming key 192 is operated (Yes in ACT SP71). In addition, the control unit 301 waits until the confirming key 192 and the ordering existence key 193 are operated (No in ACT SP69; No in ACT SP71).

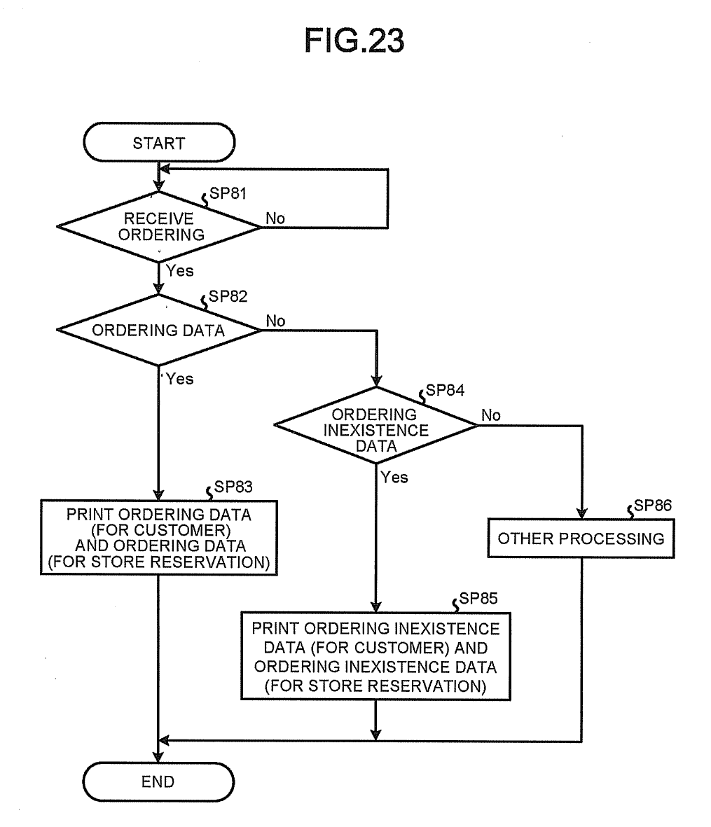

The processing of the portable printer 200 is described by using FIG. 23. The control unit 360 executes the following control. The control unit 360 judges whether or not the received data exist in the wireless receiving unit 153 (ACT SP81), in the situation that the received data exist in the wireless receiving unit 153 (Yes in ACT SP81), the control unit 360 judges whether or not the received data are the printing information such as the commodity information, the customer name, the delivery target date and the like sent from the wireless communication unit 131 of the order-taker terminal 9 in ACT SP64 (ACT SP82), and if the received data are the printing information (Yes in ACT SP82), the control unit 360 prints and issues a customer-oriented bill and a store reservation-oriented bill on which the printing information is printed (ACT SP83).

In the situation that the received data are not the printing information such as the commodity information, the customer name, the delivery target date and the like (No in ACT SP82), the control unit 360 next judges whether or not the received data are the printing information of the ordering inexistence sent in ACT SP70 (ACT SP84), and if the received data are the printing information of the ordering inexistence (Yes in ACT SP84), the control unit 360 prints and issues the customer-oriented bill 211 and the store reservation-oriented bill 212 on which the information of the ordering inexistence is printed (ACT SP85). If the received data are not the printing information of the ordering inexistence (No in ACT SP84), the control unit 360 executes other processing (ACT SP86).

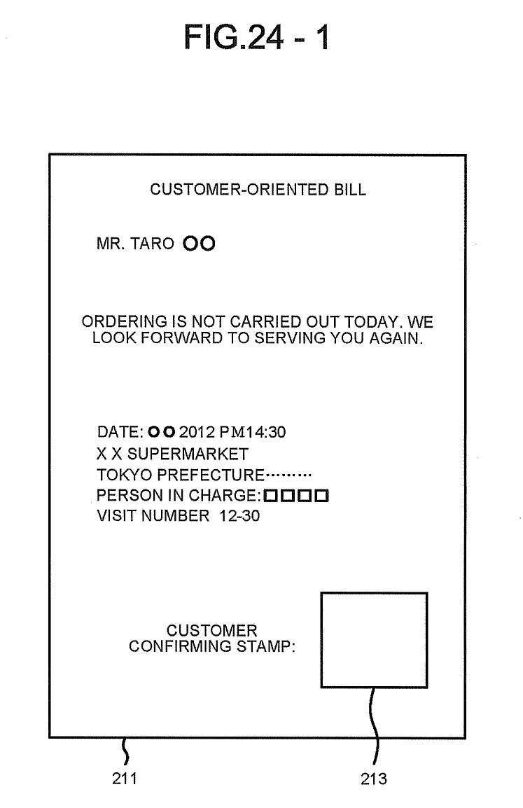

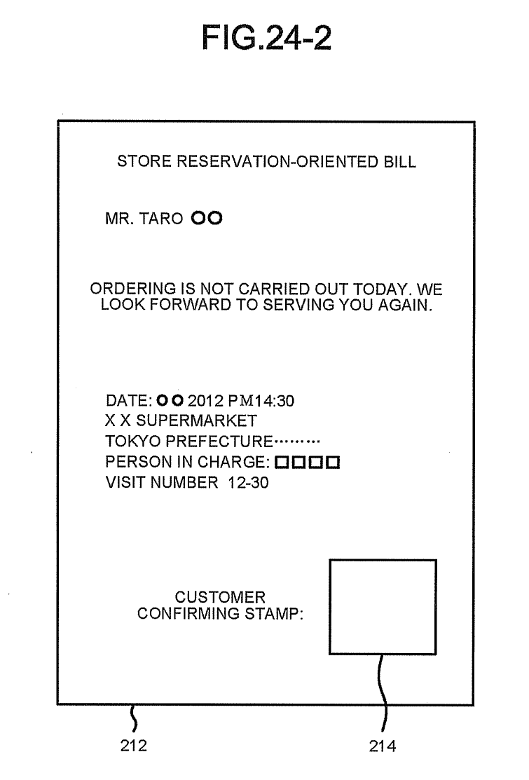

An example of the customer-oriented bill on which the printing information of the ordering inexistence is printed is illustrated in FIG. 24-1, and an example of the store reservation-oriented bill on which the printing information of the ordering inexistence is printed is illustrated in FIG. 24-2. In the examples, the information that the ordering is not carried out is printed on the customer-oriented bill 211 and the store reservation-oriented bill 212. In addition, stamping spaces 213 and 214 stamped by the customer are respectively printed on the customer-oriented bill 211 and the store reservation-oriented bill 212. As a printing example of the information that the ordering is not carried out, for example, “the ordering is not carried out today, and utilize again please” and the like are printed. In addition, the stamping spaces 213 and 214 are bars stamped by the customer confirming that the ordering is not carried out.

In the present embodiment with such configurations, when the staff holds the order-taker terminal 9 to visit each family, in the situation that the ordered commodity from the customer does not exist, the information of the ordering inexistence is sent to the external printing apparatus, therefore, for example, if the customer-oriented bill 211 and the store reservation-oriented bill 212 are printed and issued by utilizing the portable printer 200 receiving the sent information of the ordering inexistence, it can prove that the order-taking is carried out on the residence, moreover, it can also prove that the order-taking is carried out but the ordering does not exist, and therefore, the trouble or the misunderstanding between the fact that the order-taking is carried out or the order-taking is not carried out and the customer can be prevented. In addition, the deceit of such a staff who actually does not carry out the order-taking but lies that the order-taking is carried out can be also prevented.

In the present embodiment, as the commodity information subjected to the order-taking can be sent to the exterior in the residence visited by the staff in the wireless manner, the ordering information can be mastered quite easily.

In the present embodiment, when the staff holds the order-taker terminal 9 to visit each family, in the situation that the ordered commodity from the customer does not exist, the data of the ordering inexistence can be sent to the portable printer 200, and therefore, the situation that the order-taking is carried out and the situation that the ordering does not exist can be confirmed by utilizing the portable printer 200.

In the present embodiment, when the staff holds the order-taker terminal 9 to visit each family, in the situation that the ordered commodity from the customer does not exist, the information of the ordering inexistence is sent to the portable printer 200, the information of the ordering inexistence is printed as the customer-oriented bill 211 and the store reservation-oriented bill 212 and is issued by utilizing the portable printer 200 receiving the information of the ordering inexistence, thus, it can prove that the order-taking is carried out in the residence, moreover, it can also prove the situation that the order-taking is carried out but the ordering is not carried out, and therefore, the trouble or the misunderstanding between the fact that the order-taking is carried out or the order-taking is not carried out and the customer can be prevented. In addition, the deceit of such a staff who actually does not carry out the order-taking but lies that the order-taking is carried out can be also prevented.

In the present embodiment, the stamping spaces 213 and 214 of the customer are respectively printed on the customer-oriented bill 211 and the store reservation-oriented bill 212. In such a manner, the stamping of the customer can be acquired on the stamping spaces 213 and 214. Therefore, by storing the customer-oriented bill 211 by the customer and storing the store reservation-oriented bill 212 by the store, it can definitely prove that the visit is carried out in the residence of the customer, and therefore, the trouble or the misunderstanding between the fact that the order-taking is carried out or the order-taking is not carried out and the customer can be prevented. In addition, the deceit of the staff can be also prevented reliably.

In the present embodiment, in the situation that the customer cancels the ordered commodity to generate the ordering inexistence after login, the situation that the ordering is not carried out together with the login ID is sent to the online supermarket server 18, and therefore, the situation that the staff carries out the visit in the residence can be managed.

In the present embodiment, as the customer-oriented bill 211 and the store reservation-oriented bill 212 are printed and issued, the customer and the store both can keep the bills, and therefore, the trouble with the customer along with the divergence of the commodity subjected to the order-taking between the customer and the store, the misunderstanding whether or not the order-taking is carried out, the misunderstanding whether or not the ordering does not exist, and the like, can be prevented.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, in the present embodiment, the sending of the printing information carried out on the portable printer 200 from the order-taker terminal 9 is sent in the wireless manner utilizing the Bluetooth technology, but other wireless technologies can be also used. In addition, the data can be also sent similarly by using, for example, an infrared technology except the wireless technology.

In the present embodiment, the customer-oriented bill 211 and the store reservation-oriented bill 212 are printed and issued from the portable printer 200, but the store reservation-oriented bill 212 can be also at least issued.

In the present embodiment, the stamping spaces of the customer are printed on both of the customer-oriented bill 211 and the store reservation-oriented bill 212, but the stamping space can be also only printed on the store reservation-oriented bill 212.

In the present embodiment, the stamping space 213 and 214 of the customer are printed on the customer-oriented bill 211 and the store reservation-oriented bill 212, but the stamping spaces can be also replaced to print signature spaces signed by the customer. Of course, the signature space can be also only printed on the store reservation-oriented bill 212.

In the present embodiment, the customer uses the ordering inexistence key 164 to designate that the ordering does not exist, but this is an example only, and other known methods can be also used.

The program executed in the portable information processing apparatus in the present embodiment is provided by being recorded in a computer-readable recording medium such as a CD-ROM, the FD, a CD-R, a DVD (Digital Versatile Disk) and the like by using a file in an installable form or an executable form.

The program executed by the portable information processing apparatus of the present embodiment can be also constituted to be provided by being stored in a computer connected to a network such as an internet and the like and being downloaded through a network route. In addition, the program executed by the portable information processing apparatus of the present embodiment can be also constituted to be provided or allocated through the network such as the internet and the like.

The program executed by the portable information processing apparatus of the present embodiment can be also constituted to be provided by being previously assembled in the ROM 122 and the like.

What is claimed is:

1. A portable information processing apparatus, comprising:
a display configured to display information;
a sending unit configured to send the information to an exterior;
a commodity display unit configured to display multiple pieces of commodity information on the display;
a designated commodity storage unit configured to store the information of a designated commodity in displayed commodities;
an order inexistence designating unit configured to designate ordering inexistence; and
a printing information output unit configured to send the information of the ordering inexistence as printing information from the sending unit to an external printing apparatus in a situation that the ordering inexistence is designated by the ordering inexistence designating unit.

2. The portable information processing apparatus according to claim 1, wherein
the sending unit includes a wireless sending unit and sends the commodity information designated by the designated commodity storage unit to the exterior as the ordering information of a customer by the wireless sending unit.

3. The portable information processing apparatus according to claim 2, wherein
the information of the ordering inexistence is sent to the exterior as the information of the customer by the wireless sending unit in a situation that the ordering inexistence is designated.

4. A carrying-oriented information input system includes the portable information processing apparatus according to claims 1 and a receiving unit, wherein
the portable printing apparatus, including:
a bill issuing unit configured to issue a confirmation bill on which printing information is printed in a situation that the receiving unit receives the printing information of ordering inexistence.

5. The carrying-oriented information input system according to claim 4, wherein
the bill issuing unit respectively issues a customer-oriented bill on which the printing information of the ordering inexistence is printed and a store-oriented bill on which the printing information of the ordering inexistence and a signature space or a stamping space are printed.

6. A method, comprising:
displaying multiple pieces of commodity information on a display;
storing the information of a designated commodity in displayed commodities;
designating ordering inexistence; and
sending the information of the ordering inexistence as printing information to an external printing apparatus in a situation that the ordering inexistence is designated.
